(19) United States
(12) Patent Application Publication
(10) Pub. No.: US 2012/0013615 A1
(43) Pub. Date: Jan. 19, 2012

(54) PLASMA DISPLAY DEVICE

(76) Inventors: Kaname Mizokami, Kyoto (JP); Shinsuke Yoshida, Osaka (JP); Takahiko Origuchi, Osaka (JP); Yuya Shiozaki, Osaka (JP)

(21) Appl. No.: 13/258,175

(22) PCT Filed: Mar. 11, 2011
(86) PCT No.: PCT/JP2011/001427

§ 371 Date: Sep. 21, 2011

(30) Foreign Application Priority Data
Mar. 18, 2010 (JP) 2010-062327

(51) Int. Cl. G06T 15/00; G09G 3/28

(52) U.S. Cl. 345/419; 345/60

(57) ABSTRACT

Provided is a plasma display device including a plasma display panel that performs gradation display of an image by a sub-field driving method. A protective layer of the plasma display panel includes a base layer formed on a dielectric layer and a plurality of aggregated particles dispersed all over a surface of the base layer. The plasma display device forms an image by a right-eye field in which a right-eye image signal is displayed and a left-eye field in which a left-eye image signal is displayed. The right-eye field and the left-eye field have a plurality of sub-fields. The first sub-field has a minimum luminance weight, the second sub-field has a maximum luminance weight, and the third and subsequent sub-fields have luminance weights decreasing in sequence.

### TECHNICAL FIELD

A technique disclosed here relates to a plasma display device used in a display device or the like.

### BACKGROUND ART

A plasma display panel (hereinafter, referred to as a PDP) has a front plate and a rear plate. The front plate has a glass substrate, a display electrode formed on one main surface of the glass substrate, a dielectric layer to cover the display electrode and serve as a capacitor, and a protective layer made of a magnesium oxide (MgO) formed on the dielectric layer. Meanwhile, the rear plate has a glass substrate, a data electrode formed one main surface of the glass substrate, a base dielectric layer to cover the data electrode, a barrier rib formed on the base dielectric layer, and phosphor layers formed between the barrier ribs and emitting red, green, blue light, respectively.

The front plate and the rear plate are hermetically sealed such that electrode forming surface sides thereof face each other. A discharge gas of neon (Ne) and xenon (Xe) is sealed in a discharge space partitioned by a barrier rib. The discharge gas discharges electricity by a video signal voltage selectively applied to a display electrode. Ultraviolet rays generated by electric discharge excite the phosphor layers. The excited phosphor layers emit red, green, and blue light. A PDP realizes a color image display as described above (see Patent Document 1).

### CITATION LIST

### Patent Literature

PTL1 Unexamined Japanese Patent Publication No. 2003-128430

### SUMMARY OF THE INVENTION

A plasma display device in the first disclosure includes a PDP that performs gradation display of an image by a sub-field driving method. The PDP has a front plate and a rear plate disposed to oppositely to the front plate. The front plate has a display electrode, a dielectric layer to cover the display electrode, and a protective layer to cover the dielectric layer. The protective layer includes a base layer formed on the dielectric layer and a plurality of aggregated particles dispersed all over a surface of the base layer. The aggregated particles include a plurality of aggregated crystal particles of a metal oxide. Furthermore, the plasma display device forms an image by a right-eye field in which a right-eye image signal is displayed and a left-eye field in which a left-eye image signal is displayed. The right-eye field and the left-eye field have a plurality of sub-fields. The first sub-field has a minimum luminance weight, the second sub-field has a maximum luminance weight, and the third and subsequent sub-fields have luminance weights decreasing in sequence.

A plasma display device in the second disclosure includes a PDP that performs gradation display of an image by a sub-field driving method. The PDP has a front plate and a rear plate arranged to face the front plate. The front plate has a display electrode, a dielectric layer to cover the display electrode, and a protective layer to cover the dielectric layer. The protective layer includes a base layer formed on the dielectric layer, a plurality of first particles dispersed all over the surface of the base layer, and a plurality of second particles dispersed all over the surface of the base layer. The first particle includes a plurality of aggregated crystal particles of a metal oxide. The second particle is a cubic crystal particle made of a magnesium oxide. Furthermore, the plasma display device forms an image by a right-eye field in which a right-eye image signal is displayed and a left-eye field in which a left-eye image signal is displayed. The right-eye field and the left-eye field have a plurality of sub-fields. The first sub-field has a minimum luminance weight, the second sub-field has a maximum luminance weight, and the third and subsequent sub-fields have luminance weights decreasing in sequence.

### BRIEF DESCRIPTION OF THE DRAWINGS

FIG. 1 is a perspective view showing a structure of a PDP.

FIG. 2 is an electrode arrangement view of the PDP.

FIG. 3 is a block circuit diagram of a plasma display device.

FIG. 4 is a drive voltage waveform chart of the plasma display device according to an embodiment.

FIG. 5 is a pattern diagram showing a sub-field configuration of the plasma display device according to the embodiment.

FIG. 6 is a diagram showing coding in the plasma display device according to the embodiment.

FIG. 7 is a schematic sectional view showing a configuration of a front plate according to the embodiment.

FIG. 8 is an enlarged diagram of a protective layer portion according to the embodiment.

FIG. 9 is an enlarged diagram of a protective layer surface according to the embodiment.

FIG. 10 is an enlarged diagram of aggregated particles according to the embodiment.

FIG. 11 is a diagram showing a cathode luminescence spectrum of a crystal particle according to the embodiment.

FIG. 12 is a diagram showing a relationship between electron emission performance and a Vscn lighting voltage.

FIG. 13 is a diagram showing a relationship between a lighting time of a PDP and electron emission performance.

FIG. 14 is an enlarged diagram for explaining a coverage.

FIG. 15 is a characteristics graph showing sustain discharge voltages in comparison with each other.

FIG. 16 is a characteristics graph showing a relationship between an average particle diameter of the aggregated particle and electron emission performance.

FIG. 17 is a characteristics graph showing a relationship between a particle diameter of a crystal particle and a breakage rate of a barrier rib.

FIG. 18 is a process diagram showing steps in forming a protective layer according to the embodiment.

### DESCRIPTION OF EMBODIMENTS

1. Configuration of PDP 1

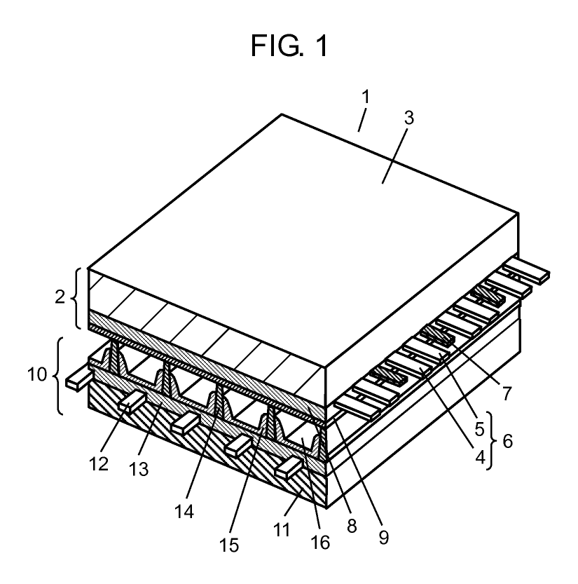

A basic structure of a PDP corresponds to that of a general alternating current (AC) surface discharge type PDP. As shown in FIG. 1, PDP 1 is provided in such a manner that front plate 2 including front glass substrate 3, and rear plate 10 including rear glass substrate 11 are arranged so as to be opposed to each other. Peripheral parts of front plate 2 and rear plate 10 are hermetically sealed by a sealing material such as a glass frit. A discharge gas such as neon (Ne) and xenon (Xe) is sealed at a pressure of 53 kPa (400 Torr) to 80 kPa (600 Torr) in discharge space 16 provided in sealed PDP 1.

Pairs of band-shaped display electrodes 6 each composed of scan electrode 4 and sustain electrode 5, and black stripes 7 are arranged on front glass substrate 3 so as to be parallel to each other. Dielectric layer 8 serving as a capacitor is formed on front glass substrate 3 so as to cover display electrodes 6 and black stripes 7. In addition, protective layer 9 composed of a magnesium oxide (MgO) is formed on a surface of dielectric layer 8.

Each of scan electrode 4 and sustain electrode 5 is constituted in such a manner that a bus electrode composed of Ag is laminated on a transparent electrode composed of a conductive metal oxide such as an indium tin oxide (ITO), tin oxide (SnO₂), or zinc oxide (ZnO).

Data electrodes 12 each composed of a conductive material mainly containing silver (Ag) are arranged parallel to each other on rear glass substrate 11 in a direction perpendicular to display electrodes 6. Data electrode 12 is covered with base dielectric layer 13. Furthermore, barrier rib 14 having a predetermined height is formed on base dielectric layer 13 between data electrodes 12 to section discharge space 16. Phosphor layer 15 emitting red light, phosphor layer 15 emitting green light, and phosphor layer 15 emitting blue light under ultraviolet rays are sequentially applied and formed with respect to each data electrode 12, in a groove formed between barrier ribs 14. A discharge cell is formed at a position in which display electrode 6 and data electrode 12 intersect with each other. The discharge cell having red, green, and blue phosphor layers 15 arranged in a direction along display electrode 6 serves as a pixel for a color display.

In addition, according to this embodiment, the discharge gas sealed in discharge space 16 contains not smaller than 10% by volume and not larger than 30% by volume of Xe.

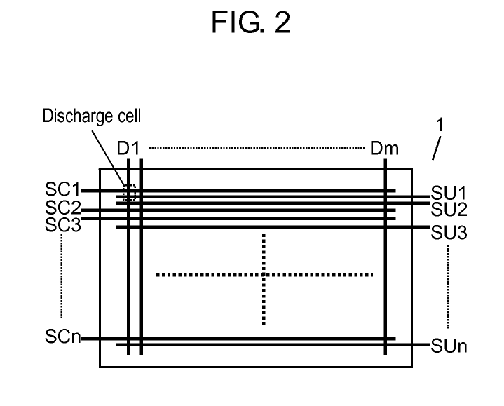

As shown in FIG. 2, PDP 1 has n scan electrodes SC1 to SCn arranged so as to extend in a longitudinal direction. Furthermore, PDP 1 has n sustain electrodes SU1 to SUn arranged so as to extend in a longitudinal direction. PDP 1 has m data electrodes D1 to Dm arranged so as to extend in a latitudinal direction. The discharge cell is formed at a part in which scan electrode SC1 and sustain electrode SU1 intersect with data electrode D1. In the discharge space, m x n discharge cells are formed. A region in which the discharge cells are arranged is an image display region. Each of the scan electrode and the sustain electrode is connected to a connection terminal provided in a peripheral end of the front plate outside an image display region. The data electrode is connected to a connection terminal provided in a peripheral end of the rear plate outside an image display region.

2. Configuration of plasma display device 100

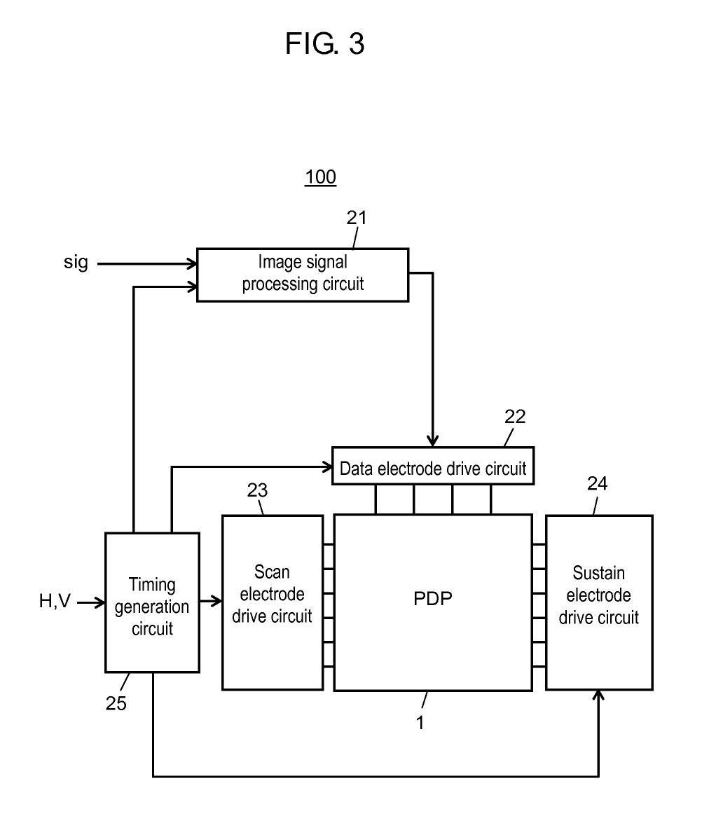

As shown in FIG. 3, plasma display device 100 includes PDP 1, image signal processing circuit 21, data electrode drive circuit 22, scan electrode drive circuit 23, sustain electrode drive circuit 24, timing generation circuit 25, and a power supply circuit (not shown).

Image signal processing circuit 21 alternately receives a right-eye image signal and a left-eye image signal in units of fields. Furthermore, image signal processing circuit 21 converts the inputted right-eye image signal into right-eye image data representing emission of light or non-emission of light with respect to each subfield. Furthermore, image signal processing circuit 21 converts the inputted left-eye image signal into left-eye image data representing emission of light or non-emission of light with respect to each subfield. Data electrode drive circuit 22 converts the right-eye image data and the left-eye image data into address pulses corresponding to data electrode D1 to data electrode Dm. Furthermore, data electrode drive circuit 22 applies the address pulses to data electrode D1 to data electrode Dm, respectively.

Timing generation circuit 25 generates various kinds of timing signals based on horizontal synchronizing signal H and vertical synchronizing signal V and supplies them to each drive circuit block. A timing signal at which a shutter of shutter glasses are opened or closed is outputted to a timing signal output unit. The timing signal output unit (not shown) uses a light emitting element such as an LED to convert the timing signal into, for example, an infrared signal and to supply the timing signal to the shutter glasses (not shown). Scan electrode drive circuit 23 supplies a drive voltage waveform to scan electrodes based on the timing signal. Sustain electrode drive circuit 24 supplies a drive voltage waveform to sustain electrode based on the timing signal. The shutter glasses (not shown) has a receiving unit that receives the timing signal outputted from the timing signal output unit (not shown), right-eye liquid crystal shutter R, and left-eye liquid crystal shutter L. Furthermore, the shutter glasses (not shown) opens/closes right-eye liquid crystal shutter R and left-eye liquid crystal shutter L on the basis of the timing signal.

In the embodiment, one field includes, as an example, five sub-fields (SF1, SF2, SF3, SF4, and SF5). In an initializing period of sub-field SF1 arranged at the start of the field, a forcible initializing operation is performed. In the initializing periods of sub-fields SF2 to SF5 arranged subsequent to sub-field SF1, a selective initializing operation is performed.

The luminance weight of sub-field SF1 is 1. The luminance weight of sub-field SF2 is 16. The luminance weight of sub-field SF3 is 8, and the luminance weight of sub-field SF4 is 4. The luminance weight of sub-field SF5 is 2. More specifically, a sub-field having the minimum luminance weight is first sub-field SF1. A sub-field having the maximum luminance weight is second sub-field SF2. Third and subsequent sub-fields have luminance weights that decrease in sequence.

3. Driving method of PDP 1

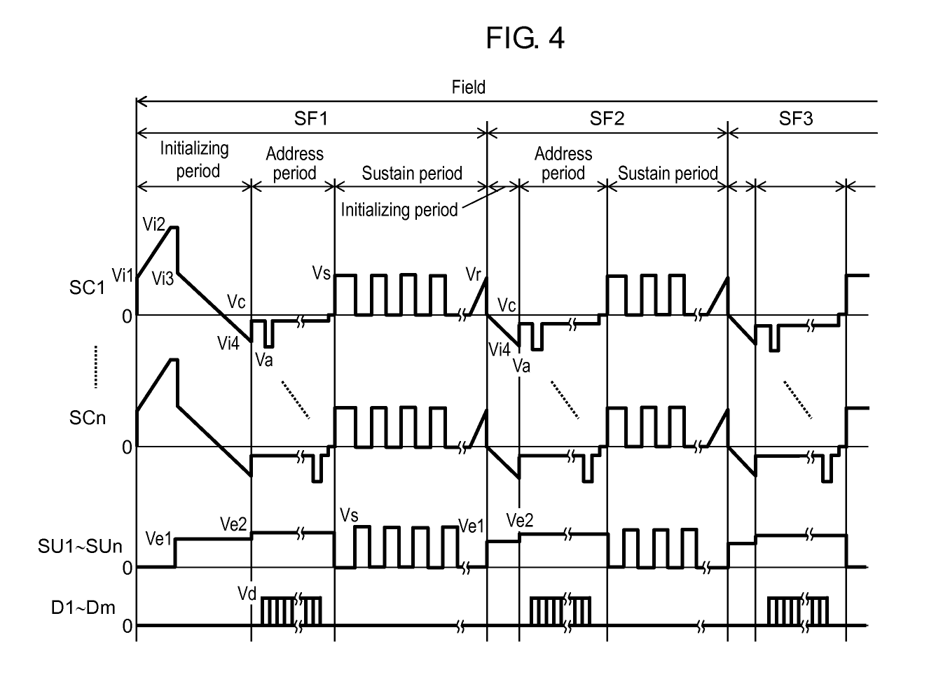

As shown in FIG. 4, PDP 1 in the embodiment is driven by a sub-field driving method. In the sub-field driving method, one field includes a plurality of sub-fields. The subfield has an initializing period, an address period, and a sustain period. During the initializing period, an initializing discharge is generated in the discharge cell. During the address period, an address discharge is generated to select the discharge cell which emits light, after the initializing period. During the sustain period, a sustain discharge is generated in the discharge cell selected in the address period.

3-1-1. Initializing Period

During the initializing period of the first subfield, data electrodes D1 to Dm and sustain electrodes SU1 to SUn are held at 0 (V). In addition, a ramp voltage gradually rising from voltage Vi1 (V) which is a discharge start voltage or lower, to voltage Vi2 (V) which exceeds the discharge start voltage is applied to scan electrodes SC1 to SCn. Then, a first weak initializing discharge is generated in all of the discharge cells. A negative wall voltage is accumulated on scan electrodes SC1 to SCn by the initializing discharge. A positive wall voltage is accumulated on sustain electrodes SU1 to SUn and data electrodes D1 to Dm. The wall voltage is a voltage generated by wall electric charges accumulated on protective layer 9 and phosphor layer 15.

After that, sustain electrodes SU1 to SUn are held at positive voltage Ve1 (V). A ramp voltage which gradually falls from voltage Vi3 (V) to voltage Vi4 (V) is applied to scan electrodes SC1 to SCn. Thus, a second weak initializing discharge is generated in all of the discharge cells. The wall voltage between scan electrodes SC1 to SCn and sustain electrodes SU1 to SUn is weakened. The wall voltage on the data electrodes D1 to Dm is adjusted to a value appropriate for an address operation. As described above, a forcible initializing operation that forcibly performs an initializing discharge to all the discharge cells is ended.

3-1-2. Address Period

In the address period, voltage Ve2 is applied to sustain electrodes SU1 to SUn. Voltage Vc is applied to scan electrodes SC1 to SCn. Negative scan pulse voltage Va(V) is applied to scan voltage SC1. Furthermore, a positive address pulse voltage Vd(V) is applied to data electrode Dk (k=1 to m) of discharge cells to be displayed in the first row of data electrodes D1 to Dm. At this time, a voltage at an intersection part of data electrode Dk and scan electrode SC1 is calculated by adding the wall voltage on data electrode Dk and the wall voltage on scan electrode SC1 to externally applied voltage (Vd-Va) (V). More specifically, a voltage at the intersection part of data electrode Dk and scan electrode SC1 exceeds the discharge start voltage. Thus, the address discharge is generated between data electrode Dk and scan electrode SC1 and between sustain electrode SU1 and scan electrode SC1. A positive wall voltage is accumulated on scan electrode SC1 of the discharge cell in which the address discharge has been generated. A negative wall voltage is accumulated on sustain electrode SU1 of the discharge cell in which the address discharge has been generated. A negative wall voltage is accumulated on data electrode Dk of the discharge cell in which the address discharge has been generated.

Meanwhile, a voltage at intersection parts of data electrodes D1 to Dm and scan electrode SC1 to which address pulse voltage Vd (V) has not been applied does not exceed the discharge start voltage. Consequently, the address discharge is not generated. The above address operations are sequentially performed until the discharge cell in an n-th row. The address period completes when the address operation in the discharge cell in the n-th row is completed.

3-1-3. Sustain Period

During the next sustain period, positive sustain pulse voltage Vs (V) is applied to scan electrodes SC1 to SCn as a first voltage. A ground potential, that is, 0 (V) is applied to sustain electrodes SU1 to SUn as a second voltage. At this time, a voltage between scan electrode SCi and sustain electrode SUi in the discharge cell in which the address discharge has been generated is calculated by adding the wall voltage on scan electrode SCi and the wall voltage on sustain electrode SUi to sustain pulse voltage Vs (V), and exceeds the discharge start voltage. Thus, the sustain discharge is generated between scan electrode SCi and sustain electrode SUi. The phosphor layer is excited and emits light under ultraviolet rays generated due to the sustain discharge. Thus, a negative wall voltage is accumulated on scan electrode SCi. A positive wall voltage is accumulated on sustain electrode SUi. A positive wall voltage is accumulated on data electrode Dk.

In the discharge cell in which the address discharge has not been generated during the address period, the sustain discharge is not generated. Thus, the wall voltage at the time of the completion of the initializing period is held. Then, 0 (V) serving as the second voltage is applied to the scan electrodes SC1 to SCn. Sustain pulse voltage Vs (V) serving as the first voltage is applied to the sustain electrodes SU1 to SUn. Then, in the discharge cell in which the sustain discharge has been generated, the voltage between the sustain electrode SUi and the scan electrode SCi exceeds the discharge start voltage. Therefore, the sustain discharge is generated between the sustain electrode SUi and the scan electrode SCi again. That is, a negative wall voltage is accumulated on sustain electrode SUi. A positive wall voltage is accumulated on scan electrode SCi.

Similarly, the sustain pulse voltage Vs (V) whose number corresponds to a luminance weight is alternately applied to scan electrodes SC1 to SCn and sustain electrodes SU1 to SUn, whereby the sustain discharge is continuously generated in the discharge cell in which the address discharge has been generated during the address period. When the predetermined number of applications of sustain pulse voltage Vs (V) is completed, a sustain operation in the sustain period is completed. At the end of the sustain period, a ramp waveform voltage gradually rising toward voltage Vr is applied to scan electrodes SC1 to SCn. On data electrode Dk, wall voltages on scan electrode SCi and sustain electrode SUi are weakened while keeping a positive wall voltage. Thus, the sustain operation in the sustain period is completed.

3-1-4. In Second Subfield Or Later

During the initializing period of second sub-field SF2 in which the selective initializing operation is performed, voltage Ve1 is applied to sustain electrodes SU1 to SUn. A voltage of 0 (V) is applied to data electrodes D1 to Dm. A ramp waveform voltage that gradually falls toward voltage Vi4 is applied to scan electrodes SC1 to SCn. Then, a weak initializing discharge is generated in a discharge cell in which a sustain discharge has been generated in sub-field SF1 serving as an immediately previous sub-field, and the wall voltages on scan electrode SCi and sustain electrode SUi are weakened. With respect to data electrode Dk, a positive sufficient wall voltage is accumulated on data electrode Dk by the immediately previous sustain discharge. Excessive part of the wall voltage is discharged to adjust the wall voltage to a wall voltage appropriate for an address operation. On the other hand, a discharge is not generated in a discharge cell in which the sustain discharge is not generated in the previous sub-field, and a wall voltage at the time of the completion of the initializing period of the previous sub-field is kept. The selective initializing operation is an operation that selectively performs an initializing discharge to a discharge cell in which an address operation has been performed in the address period of the immediately previous sub-field, therefore, a discharge cell in which a sustain operation is performed in the sustain period.

An operation in the next address period is the same as an operation in the address period of sub-field SF1. Consequently, a detailed description for them is omitted. An operation in the next sustain period is the same as an operation in the sustain period of sub-field SF1 except for the number of sustain pulses. Each of operations in next sub-fields SF3 to SF5 are the same as the operation in sub-field SF2 except for the number of sustain pulses.

As voltages applied to the electrodes in the embodiment, for example, voltage Vi1=145 (V), voltage Vi2=335 (V), voltage Vi3=190 (V), voltage Vi4=−160 (V), voltage Va=−180 (V), voltage Vc=−35 (V), voltage Vs=190 (V), voltage Vr=190 (V), voltage Ve1=125 (V), voltage Ve2=130 (V), and voltage Vd=60 (V) are given. These voltages can be arbitrarily set to optimum values in accordance with characteristics of PDP 1, the specification of plasma display device 100, and the like.

3-1-5. Sub-field Configuration

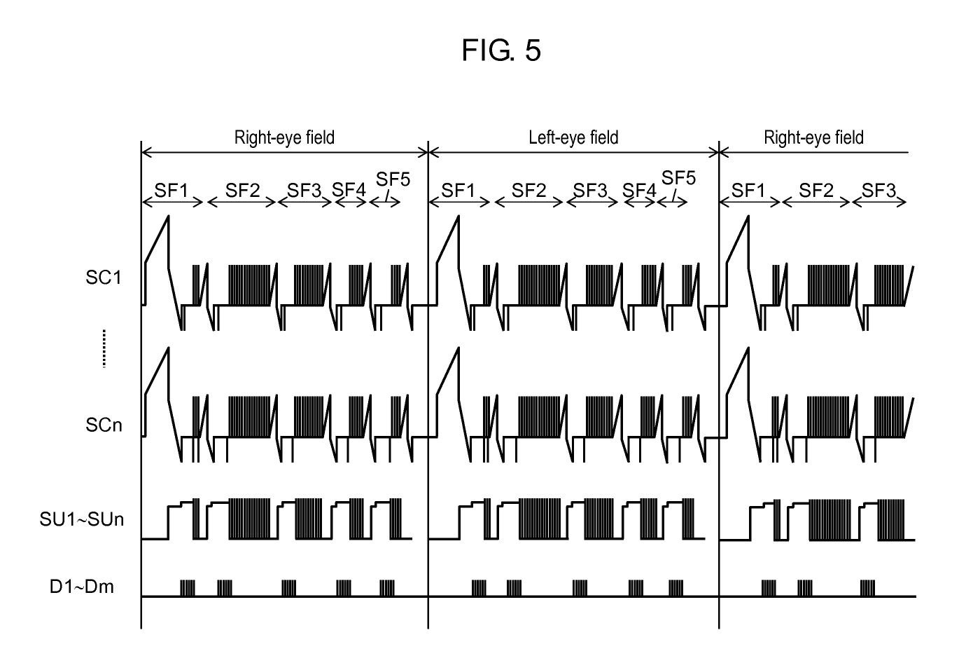

As shown in FIG. 5, in the embodiment, in order to display a three dimensional image, a field frequency is set to 120 Hz that is twice a normal frequency. Furthermore, a right-eye field and a left-eye field are alternately arranged. In one field, five sub-fields (SF1, SF2, SF3, SF4, and SF5) are arranged. The distribution of luminance weights of sub-fields are as described above.

Right-eye liquid crystal shutter R and left-eye liquid crystal shutter L of the shutter glasses receive timing signals outputted from the timing signal output unit to control the shutter glasses as follows. Right-eye liquid crystal shutter R of the shutter glasses opens the shutter in synchronization with the start of the address period of sub-field SF1 of the right-eye field, and closes the shutter in synchronization with the start of the address period of sub-field SF1 of the left-eye field. Left-eye liquid crystal shutter L opens the shutter in synchronization with the start of the address period of sub-field SF1 of the left-eye field, and closes the shutter in synchronization with the start of the address period of sub-field SF1 of the right-eye field.

The sub-fields are arranged as described above, and the shutter glasses are controlled to suppress crosstalk between a right-eye image and a left-eye image. The address discharge is stabilized to make it possible to display a high-quality three dimensional image.

An intensity of afterglow of a phosphor is in proportion to a luminance of the phosphor in emission of light. An intensity of afterglow of a phosphor is attenuated with a predetermined time constant. A light emitting luminance in the sustain period increases when the sub-fields have a large luminance weight. Therefore, in order to weaken afterglow, a sub-field having a large luminance weight is desirably arranged in an early period of the field.

On the other hand, in a discharge cell that displays an image at a bright gradient, a sustain discharge is generated in a plurality of sub-fields. Thus, a sufficient amount of priming is supplied to the discharge cell with a sustain discharge. Consequently, a stable address discharge can be generated. However, an amount of priming is short in a discharge cell that should emit light in only a field having a dark gradient, especially, a minimum luminance weight. Consequently, the address discharge easily becomes unstable.

Therefore, in the embodiment, the first sub-field in which the forcible initializing operation is performed in the initializing period has a minimum luminance weight. For this reason, an address discharge can be generated while priming generated in the forcible initializing operation is left. Thus, even in a discharge cell which is caused to emit light in only a sub-field having the minimum luminance weight, a stable address discharge can be generated. Furthermore, the second sub-field has a maximum luminance weight, and the third and subsequent sub-fields have luminance weights decreasing in sequence. Consequently, afterglow of a phosphor can be weakened at the end of the field. Consequently, crosstalk between a right eye and a left eye can be suppressed.

3-1-6. Gradation Display Method

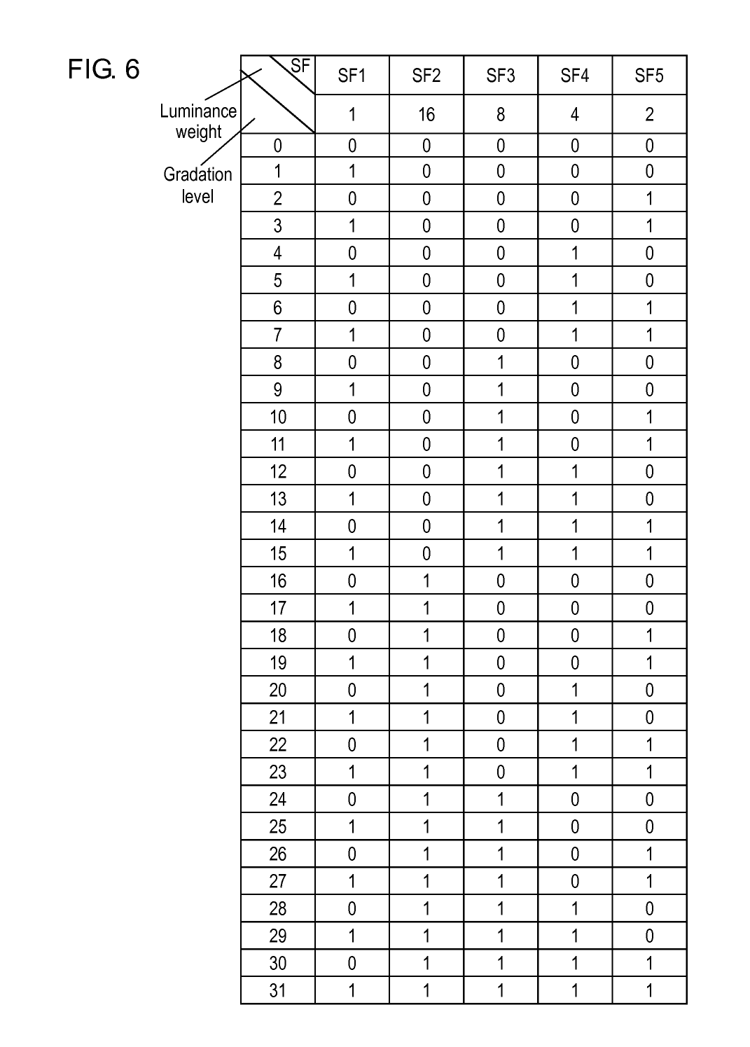

As shown in FIG. 6, in a relationship (hereinafter, referred to as coding) between a gradation level at which display should be performed and the presence/absence of an address operation of a sub-field at this time, “1” represents that the address operation is performed. “0” represents that the address operation is not performed.

According to the coding described above, in a discharge cell that displays, for example, a gradation level “0”, i.e., black, an address operation is not performed in all sub-fields SF1 to SF5. At this time, the discharge cell does not generate a sustain discharge at all, and a luminance is minimum.

In a discharge cell that displays a gradation level “1”, the address operation is performed in only sub-field SF5 having a luminance weight “1”. Furthermore, the address operation is not performed in sub-fields SF1 to SF4. Thus, the discharge cell is caused to generate a sustain discharge the number of times depending on the luminance weight “1” to display a brightness corresponding to “1”.

In a discharge cell that displays a gradation level “7”, the address operation is performed in sub-field SF3 having a luminance weight “4”, sub-field SF4 having a luminance weight “2”, and sub-field SF5 having a luminance weight “1”. At this time, the discharge cell is caused to generate a sustain discharge the number of times depending on the luminance weight “4” in the sustain period of sub-field SF3. In the sustain period of sub-field SF4, a sustain discharge is generated the number of times depending on the luminance weight “2”. In the sustain period of sub-field SF5, a sustain discharge is generated the number of times depending on the luminance weight “1”. Consequently, a brightness corresponding to a total of “7” is displayed.

The same is applied to a display having another gradation level. More specifically, according to the coding shown in FIG. 6, the presence/absence of the sustain discharge is controlled by the presence/absence of the address operations in the sub-fields.

4. Method for Producing PDP 1

4-1. Method for Producing Front Plate 2

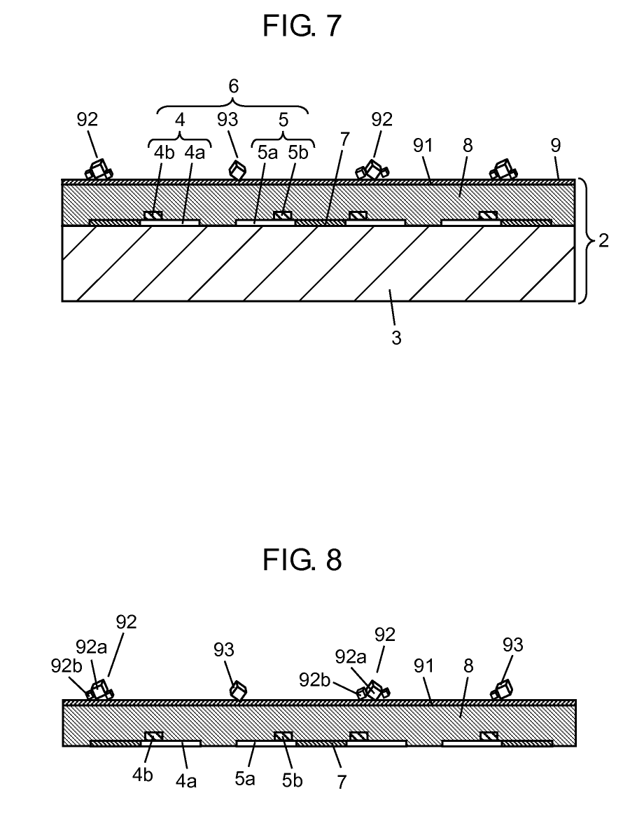

Scan electrode 4, sustain electrode 5, and black stripes 7 are formed on front glass substrate 3 by photolithography. As shown in FIG. 7, scan electrode 4 and sustain electrode 5 have metal bus electrodes 4b and 5b containing silver (Ag), respectively, to ensure conductivity. In addition, scan electrode 4 and sustain electrode 5 have transparent electrodes 4a and 5a, respectively. Metal bus electrode 4b is laminated on transparent electrode 4a. Metal bus electrode 5b is laminated on transparent electrode 5a.

Transparent electrodes 4a and 5a are each made of an ITO or the like to ensure transparency and electric conductivity. First, an ITO thin film is formed on front glass substrate 3 by sputtering. Then, transparent electrodes 4a and 5a are formed into predetermined patterns by lithography.

Metal bus electrodes 4b and 5b are made of a metal bus electrode paste containing silver (Ag), a glass frit to bind the silver, a photosensitive resin, and a solvent. First, the metal bus electrode paste is applied onto front glass substrate 3 by screen printing. Then, the solvent is removed from the metal bus electrode paste in a baking oven. Then, the metal bus electrode paste is exposed through a photomask having a predetermined pattern.

Then, the metal bus electrode paste is developed and a metal bus electrode pattern is formed. Finally, the metal bus electrode pattern is fired at a predetermined temperature in a baking oven. That is, the photosensitive resin is removed from the metal bus electrode pattern. In addition, the glass frit melts in the metal bus electrode pattern. The molten glass frit becomes glass again after the firing process. Through the above steps, metal bus electrodes 4b and 5b are formed.

Black stripe 7 is made of a material containing a black pigment. Then, dielectric layer 8 is formed. Dielectric layer 8 is made of a dielectric paste containing a dielectric glass frit, a resin, and a solvent. First, the dielectric paste is applied onto front glass substrate 3 by die coating so as to have a predetermined thickness to cover scan electrode 4, sustain electrode 5, and black stripe 7. Then, the solvent is removed from the dielectric paste in the baking oven. Finally, the dielectric paste is fired at a predetermined temperature in the baking oven. That is, the resin is removed from the dielectric paste. In addition, the dielectric glass frit melts. The molten glass frit becomes glass again after the firing process. Through the above steps, dielectric layer 8 is formed. Here, the dielectric paste may be applied by screen printing, or spin coating other than the die coating. In addition, a film used as dielectric layer 8 may be formed by CVD (Chemical Vapor Deposition) without using the dielectric paste.

Next, protective layer 9 is formed on dielectric layer 8. Protective layer 9 will be described in detail below.

Through the above steps, front plate 2 having the predetermined components on front glass substrate 3 is completed.

4-2. Method for producing rear plate 10 First, data electrode 12 is formed on rear glass substrate 11 by photolithography. Data electrode 12 is made of a data electrode paste containing silver (Ag) to ensure conductivity, a glass frit to bind the silver, a photosensitive resin, and a solvent. First, the data electrode paste is applied onto rear glass substrate 11 by screen printing so as to have a predetermined thickness. Then, the solvent is removed from the data electrode paste in the baking oven. Then, the data electrode paste is exposed through a photomask having a predetermined pattern. Then, the data electrode paste is developed, whereby a data electrode pattern is formed. Finally, the data electrode pattern is fired at a predetermined temperature in the baking oven. That is, the photosensitive resin is removed from the data electrode pattern. In addition, the glass frit melts in the data electrode pattern. The molten glass frit becomes glass again after the firing process. Through the above steps, data electrode 12 is formed. Here, the data electrode paste may be applied by sputtering or evaporation other than the screen printing.

Then, base dielectric layer 13 is formed. Base dielectric layer 13 is made of a base dielectric paste containing a dielectric glass frit, a resin, and a solvent. First, the base dielectric paste is applied onto rear glass substrate 11 having data electrode 12 by screen printing so as to have a predetermined thickness and to cover data electrode 12. Then, the solvent is removed from the base dielectric paste in the baking oven. Finally, the base dielectric paste is fired at a predetermined temperature in the baking oven. That is, the resin is removed from the base dielectric paste. In addition, the dielectric glass frit melts. The molten glass frit becomes glass again after the firing process. Through the above steps, base dielectric layer 13 is formed. Here, the base dielectric paste may be applied by die coating or spin coating other than the screen printing. In addition, a film used as base dielectric layer 13 may be formed by CVD (Chemical Vapor Deposition) without using the base dielectric paste.

Then, barrier rib 14 is formed by photolithography. Barrier rib 14 is made of a barrier rib paste containing a filler, a glass frit to bind the filler, a photosensitive resin, and a solvent. First, the barrier rib paste is applied onto base dielectric layer 13 by die coating so as to have a predetermined thickness. Then, the solvent is removed from the barrier rib paste in the baking oven. Next, the barrier rib paste is exposed through a photomask having a predetermined pattern. Then, the barrier rib paste is developed and a barrier rib pattern is formed. Finally, the barrier rib pattern is fired at a predetermined temperature in the baking oven. That is, the photosensitive resin is removed from the barrier rib pattern. In addition, the glass frit melts in the barrier rib pattern. The molten glass frit becomes glass again after the firing process. Through the above steps, barrier rib 14 is formed. Here, sandblasting may be used instead of the photolithography.

Then, phosphor layer 15 is formed. Phosphor layer 15 is made of a phosphor paste containing phosphor particles, a binder, and a solvent. First, the phosphor paste is applied onto base dielectric layer 13 provided between adjacent barrier ribs 14 and a side face of barrier rib 14 by dispensing or the like so as to have a predetermined thickness. Then, the solvent is removed from the phosphor paste in the baking oven. Finally, the phosphor paste is fired at a predetermined temperature in the baking oven. That is, the resin is removed from the phosphor paste. Through the above steps, phosphor layer 15 is formed. Here, screen printing or the like may be used instead of the dispensing.

Through the above steps, rear plate 10 having the predetermined components on rear glass substrate 11 is completed.

4-3. Assembling Method of Front Plate 2 and Rear Plate 10

Front plate 2 and rear plate 10 are assembled. A sealing material (not shown) is formed around rear plate 10 by dispensing. A sealing paste containing a glass frit, a binder, a solvent and the like are used as a material of the sealing material (not shown). Then, the solvent in the sealing paste is removed in the baking oven. Front plate 2 and rear plate 10 are arranged so as to oppose such that display electrode 6 and data electrode 12 are orthogonal to each other. Peripheries of front plate 2 and rear plate 10 are sealed by the glass frit. Finally, a discharge gas containing Ne, Xe, or the like is sealed in discharge space 16 to complete PDP 1.

5. Detail of Dielectric Layer 8

The dielectric material contains the following contents. The materials are 20% by weight to 40% by weight of a bismuth oxide (Bi₂O₃), 0.5% by weight to 12% by weight of at least one of a calcium oxide (CaO), a strontium oxide (SrO), and a barium monoxide (BaO), 0.1% by weight to 7% by weight of at least one of a molybdenum oxide (MoO₃), a tungstic oxide (WO₃), a cerium oxide (CeO₂), and a manganese dioxide (MnO₂), 0% by weight to 40% by weight of a zinc oxide (ZnO), 0% by weight to 35% by weight of a boron oxide (B₂O₃), 0% by weight to 15% by weight of a silicon dioxide (SiO₂), and 0% by weight to 10% by weight of an aluminum oxide (Al₂O₃). The dielectric material does not substantially contain a lead content.

A film thickness of dielectric layer 8 is 40 μm or less. Relative permittivity c of dielectric layer 8 is 4 or more and 7 or less. An effect obtained when relative permittivity c of dielectric layer 8 is 4 or more and 7 or less will be described below.

A dielectric material containing the component contents is broken by a wet jet mill or a ball mill into particles having an average particle diameter of 0.5 μm to 2.5 μm to manufacture a dielectric material powder. 55% by weight to 70% by weight of the dielectric material powder and 30% by weight to 45% by weight of a binder component are well mixed by a 3-roll mill to complete a paste for a first dielectric layer for die coating or printing.

A binder component is ethyl cellulose, terpineol containing 1% by weight to 20% by weight of acrylic resin, or butyl carbitol acetate. In addition, in the paste, if needed, dioctyl phthalate, dibutyl phthalate, triphenyl phosphate, or tributyl phosphate is added in the paste as a plasticizer, and glycerol monooleate, sorbitan sesquioleate, HOMOGENOL (product name of Kao Corporation), or alkyl aryl group ester phosphate is added as a dispersant. When the dispersant is added, printing properties are improved.

6. Detail of Protective Layer 9

The protective layer has four main functions. The first function is to protect the dielectric layer against ion bombardment at the time of discharging. The second function is to emit an initial electron to generate an address discharge. The third function is to hold electric charges to generate a discharge. The fourth function is to emit secondary electrons in a sustain discharge. When the dielectric layer is protected against the ion bombardment, a discharge voltage is prevented from rising. When the number of initial electron emissions is increased, an address discharge error causing a flicker of an image can be reduced. The charge retention performance is improved to reduce an applied voltage. The number of emitted secondary electrons increases to reduce a sustain discharge voltage. In order to increase the number of emitted initial electrons, for example, an attempt to add silicon (Si) or aluminum (Al) to MgO in the protective layer is performed.

However, when an impurity is mixed in MgO to improve an initial electron emission performance, a rate of decrease increases that represents a decrease of the number of electric charges accumulated in the protective layer with time. Consequently, in order to compensate for the decreased electric charges, a countermeasure that increases an applied voltage is necessary. The protective layer is required to have two conflicting characteristics, i.e., high electron emission performance and a low rate of decrease of electric charges, i.e., high charge retention performance.

Furthermore, in high-speed drive having a short address period in which the right-eye field and the left-eye field are alternately repeated, when discharge delay occurs, a defective address operation, i.e., a flicker of an image occurs.

6-1. Detail of Protective Layer 9

As shown in FIG. 8, protective layer 9 includes base film 91 serving as the base layer, aggregated particles 92 serving as first particles, and crystal particles 93 serving as second particles. Protective film 91 is, for example, a magnesium oxide (MgO) film containing aluminum (A) as an impurity. Aggregated particle 92 is obtained such that, on MgO crystal particle 92a, a plurality of crystal particles 92b each having a particle diameter smaller than that of crystal particle 92a are aggregated. Crystal particle 93 is a cubic crystal particle made of MgO. The shape can be confirmed with a scanning electron microscope (SEM). In the embodiment, the plurality of aggregated particles 92 is dispersed all over the surface of base film 91. The plurality of crystal particles 93 is dispersed all over the surface of base film 91.

Crystal particle 92a is a particle having an average particle diameter falling within the range of 0.9 μm to 2 μm. Crystal particle 92b is a particle having an average particle diameter falling within the range of 0.3 μm to 0.9 μm. In the embodiment, the average particle diameter is a cumulative volume mean diameter (D50). The average particle diameter is measured by using a laser diffraction particle size distribution analyzer MT-3300 (available from NIKKISO CO., LTD.).

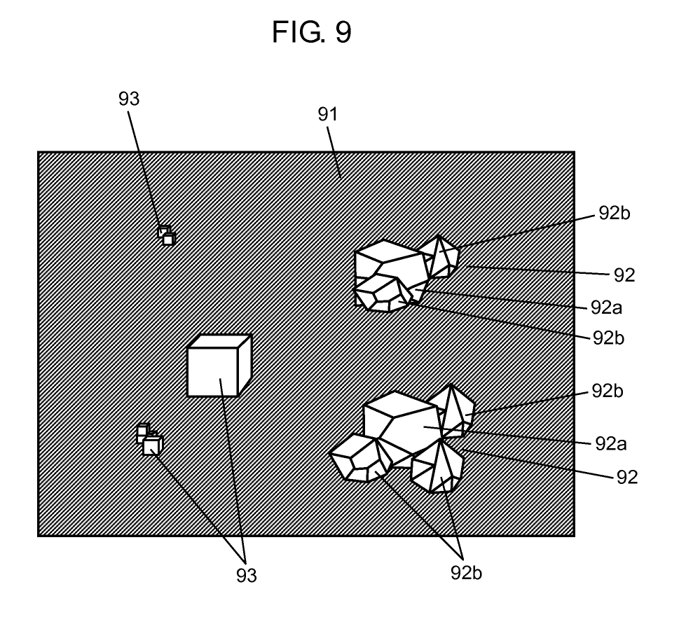

As shown in FIG. 9, on the surface of protective layer 9, aggregated particles 92 each obtained by aggregating a plurality of polyhedral crystal particles 92b on polyhedral crystal particle 92a and cubic crystal particles 93 are dispersed onto base film 91. Cubic crystal particles 93 include particles each having a particle diameter of about 200 nm and nano-particle-size particles each having a particle diameter of 100 nm or less. According to observation of actual PDP 1, some cubic crystal particles 93 are aggregated to each other, or some cubic MgO crystal particles 93 adhere to polyhedral crystal particle 92a, or polyhedral crystal particle 92b, or aggregated particle 92 of polyhedral crystal particles 92a and 92b. Polyhedral crystal particles 92a and 92b are produced by a liquid-phase method. Cubic crystal particle 93 is produced by a vapor-phase method.

Note that “cubic shape” does not mean a proper geometric cube. The shape means a shape that can be recognized as generally a cube by visually checking an electron microscopic picture. The “polyhedron” means a shape that can be recognized to have about seven or more faces by visually checking the electron microscopic picture.

6-2. Aggregated Particle 92

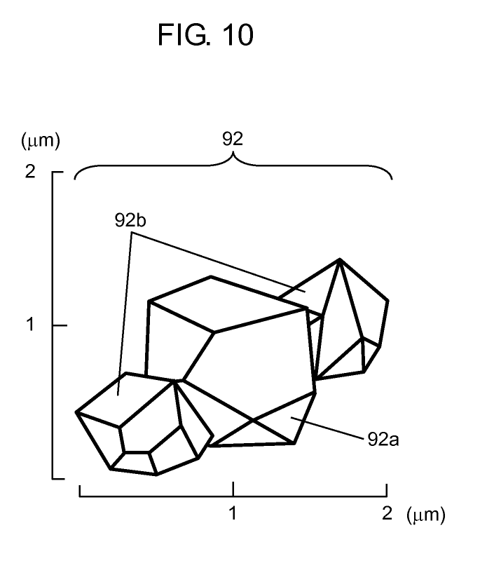

Aggregated particle 92, as shown in FIG. 10, is formed such that the plurality of crystal particles 92a and 92b each having a predetermined primary particle diameter are aggregated. Alternatively, aggregated particle 92 is formed such that the plurality of crystal particles 92a each having a predetermined primary particle diameter is aggregated. Aggregated particles 92 are not bonded by a strong bonding force as a solid substance. Aggregated particle 92 is obtained by aggregating a plurality of primary particle by static electricity or van der Waals' force. Aggregated particles 92 are bonded to each other by an external force such as an ultrasonic wave so that they partially or wholly become a primary particle state by external stimulus such as an ultrasonic wave. A particle diameter of aggregated particle 92 is about 1 μm, and crystal particles 92a and 92b have a form of a polyhedron having seven or more faces such as a cuboctahedron or dodecahedron. Crystal particles 92a and 92b are produced by a liquid-phase method that generates them by firing a solution of the precursor of MgO such as magnesium carbonate or magnesium hydroxide. The particle diameters can be controlled by adjusting a firing temperature or a firing atmosphere in the liquid-phase method. In general, the firing temperature can be selected from a range of about 700° C. to about 1500° C. When the firing temperature is set to 1000° C. or higher, the primary particle diameter can be controlled to about 0.3 to 2 μm. Crystal particles 92a and 92b can be obtained to have a state of aggregated particles 92 in which the plurality of primary particles is aggregated in its production process performed by the liquid-phase method.

On the other hand, cubic crystal particle 93 is obtained by a vapor-phase method in which magnesium is heated at a boiling temperature or higher to generate a magnesium vapor to perform vapor-phase oxidation. A crystal particle having a cubic single-crystal structure having a particle diameter of 200 nm or more (measurement result obtained by a BET method), and a multiple crystal structure in which crystalline bodies are fitted to each other are obtained. For example, a method of synthesizing a magnesium powder by the vapor-phase method is known in “Preparation and Properties of Magnesia Powder by Vapor Phase Oxidation Process” Vol. 36, No. 410, Journal of “Materials” and the like.

When a crystal particle having a cubic single crystal structure having an average particle diameter of 200 nm or more is to be formed, a heating temperature when a magnesium vapor is generated is increased, and the length of a flame generated when magnesium reacts with oxygen is increased. A difference between the temperature of the flame and an ambient temperature increases to obtain an MgO crystal particle having a larger particle diameter and produced by a vapor-phase method.

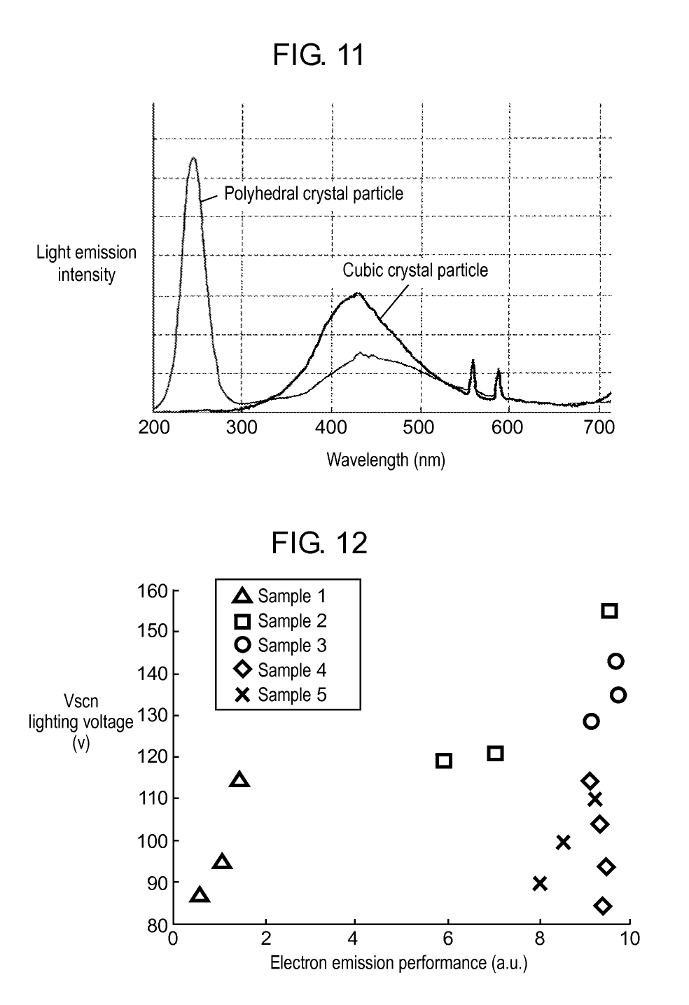

With respect to polyhedral crystal particles 92a and 92b and cubic crystal particle 93, cathode luminescence (CL) emission characteristics are measured. As shown in FIG. 11, a thin solid line indicates the emission intensities of polyhedral MgO crystal particles 92a and 92b, i.e., the cathode luminescence (emission) intensity of aggregated particle 92. A thick solid line indicates the cathode luminescence (emission) intensity of cubic MgO crystal particle 93.

As shown in FIG. 11, aggregated particle 92 obtained by aggregating several polyhedral crystal particles 92a and 92b has an emission intensity peak in a wavelength region from a wavelength of 200 nm or more to a wavelength of 300 nm or less, in particular, a wavelength of 230 nm or more to a wavelength of 250 nm or less. Cubic MgO crystal particle 93 does not have an emission intensity peak in a wavelength region from a wavelength of 200 nm or more to a wavelength of 300 nm or less. However, crystal particle 93 has an emission intensity peak in a wavelength region from a wavelength of 400 nm or more to 450 nm or less. More specifically, aggregated particle 92 caused to adhere to base film 91 and obtained by aggregating several polyhedral crystal particles 92a and 92b and cubic MgO crystal particle 93 have energy levels corresponding to the wavelengths of the emission intensity peaks.

7. Sample Evaluation Result

7-1. Configuration of Sample

First, a plurality of PDPs having protective layers having difference configurations is experimentally produced.

Sample 1 is a PDP having a protective layer configured by only an MgO film.

Sample 2 is a PDP having a protective layer made of only MgO and doped with an impurity such as Al or Si.

Sample 3 is a PDP provided such that only primary particles of crystal particles made of a metal oxide are dispersed on base film 91 made of MgO.

Sample 4 is PDP 1 provided such that aggregated particles 92 composed of MgO crystal particles having equal particle diameters are dispersed all over base film 91 made of MgO. More specifically, sample 4 is PDP 1 provided such that the plurality of aggregated particles 92 is dispersed all over the surface of base film 91.

Sample 5 is a PDP that has protective layer 9 in which polyhedral aggregated particles 92 obtained by aggregating MgO crystal particles 92b each having a particle diameter smaller than that of crystal particle 92a around MgO crystal particles 92a having an average particle diameter falling within the range of 0.9 μm to 2 μm and cubic MgO crystal particle 93 adhere to base film 91 made of MgO so as to distribute them all over the surface of base film 91. More specifically, sample 5 is PDP 1 in which the plurality of aggregated particles 92 and a plurality of crystal particles 93 are dispersed all over the surface of base film 91. PDP 1 in which the plurality of aggregated particles 92 and the plurality of crystal particles 93 are uniformly dispersed all over the surface of base film 91 is more preferable. This is because a fluctuation in discharge characteristic in a plane of PDP 1 can be suppressed.

7-2. Performance Evaluation

With respect to PDPs having the configurations of the protective films of five types, electron emission performance and charge retention performance are measured.

As for the electron emission performance, as its value increases, an electron emission amount becomes large. The electron emission performance is expressed as an initial electron emission amount determined by a surface state of the discharge, a gas kind, and its state. The initial electron emission amount can be measured by measuring an electronic current amount emitted from the surface when the surface is irradiated with an ion or electron beam. However, it is difficult to measure by a nondestructive way. Thus, a method disclosed in Unexamined Japanese Patent Publication No. 2007-48733 is used. That is, the method measures a value which provides an indication of ease of discharge generation, called a statistical delay time of delay times of the discharge. When an inverse number of the statistical delay time is integrated, the value linearly corresponds to the emission amount of the initial electrons. The delay time of the discharge corresponds to a time from rising of the address discharge pulse until the address discharge is generated later. The discharge delay is supposed to be mainly caused because the initial electron serving as the trigger to generate the address discharge is not easily emitted from the protective layer surface to the discharge space.

The charge retention performance uses, as an index thereof, a voltage value of a voltage (hereinafter, referred to as a Vscn lighting voltage) applied to the scan electrode required to prevent an electric charge emission phenomenon when the sample is produced as the PDP. That is, the lower the Vscn lighting voltage is, the higher the charge retention ability is. When the Vscn lighting voltage is low, the PDP can be driven at a low voltage. Thus, a component which is low in breakdown voltage and low in capacity can be used as a power supply or an electric component. As for a current product, an element having a breakdown voltage as low as 150 V is used as a semiconductor switching element such as a MOSFET provided to sequentially apply the scan voltage to the panel. The Vscn lighting voltage is preferably 120 V or lower in view of a variation due to temperature.

As is apparent from FIG. 12, in the evaluation of the charge retention performance, each of samples 4 and 5 can make the Vscn lighting voltage 120 V or lower. In addition, each of samples 4 and 5 can obtain a preferable characteristic, i.e., an electron emission performance of 6 or more.

In general, the electron emission ability of the protective layer of the PDP contradicts with the charge retention ability thereof. For example, the electron emission performance can be improved by changing a condition for forming the protective layer, or doping an impurity such as Al, Si, or Ba in the protective layer in a film formation process. However, the Vscn lighting voltage also rises as an adverse effect. In the PDP having the protective layer according to the embodiment, the electron emission ability that is 6 or more and the charge retention ability having the Vscn lighting voltage of 120 V or lower can be obtained. More specifically, a protective layer having both the electron emission ability and the charge retention ability that can cope with a PDP in which the number of scan lines increases due to high definition and the cell size of which tends to be decreased can be obtained.

A result obtained by examining a change with time in electron emission performance of protective layer 9 will be described. In order to elongate the life of a PDP, the electron emission performance of protective layer 9 is required not to be deteriorated with time.

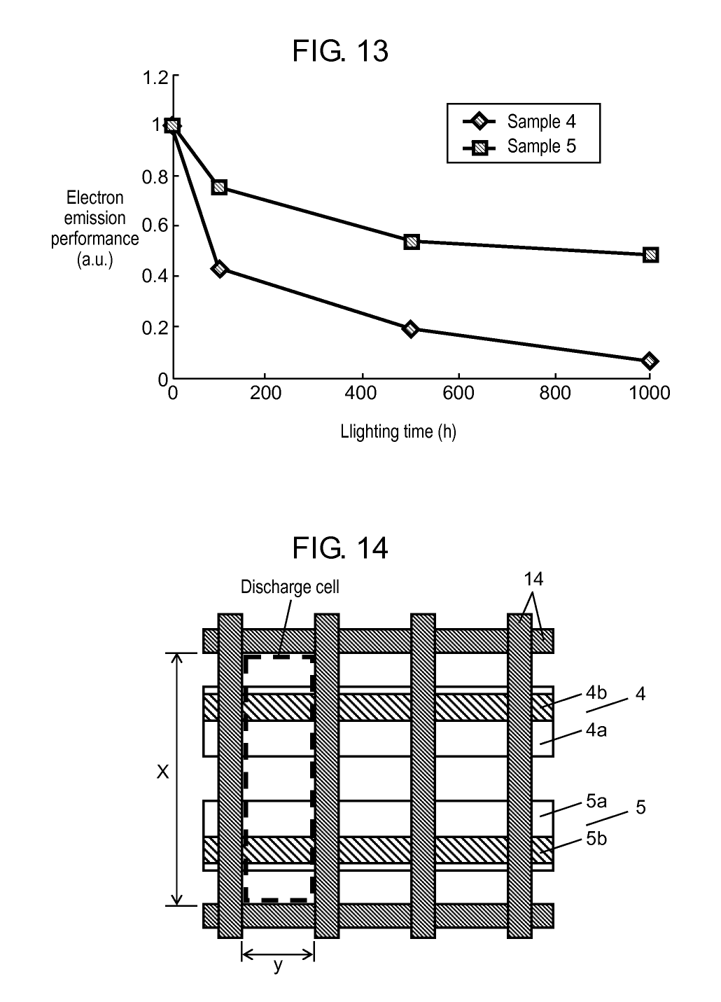

As results obtained by examining deterioration with time of the electron emission performance of samples 4 and 5 that acquire preferable characteristics in FIG. 12, transition of the electron emission performance with respect to a lighting time of the PDP is shown in FIG. 13. As shown in FIG. 13, sample 5 in which polyhedral aggregated particles 92 obtained by aggregating MgO crystal particles 92b each having a particle diameter smaller than that of crystal particle 92a around MgO crystal particles 92a having an average particle diameter falling within the range of 0.9 μm to 2 μm and cubic MgO crystal particle 93 are dispersed all over the surface of base film 91 containing MgO has deterioration with time of the electron emission performance less than that of sample 4.

In sample 4, it is estimated that ions generated by a discharge in a PDP cell impacts the protective layer to peel aggregated particles 92. On the other hand, in sample 5, MgO crystal particles 92b each having a further smaller average particle diameter are aggregated around MgO crystal particles 92a having an average particle diameter falling within the range of 0.9 μm to 2 μm. More specifically, since crystal particle 92b having a small particle diameter has a large surface area, crystal particle 92b has high adhesion properties to base film 91, and it is estimated that aggregated particle 92 is rarely peeled by ion bombardment.

In the PDP serving as sample 5, a characteristic of 6 or more can be obtained as the electron emission ability, and a Vscn lighting voltage of 120 V or lower can be obtained as the charge retention ability. More specifically, a protective layer having both the electron emission ability and the charge retention ability that can cope with a PDP in which the number of scan lines increases due to high definition and the cell size of which tends to be decreased can be obtained. Furthermore, since deterioration with time of the electron emission performance is small, stable image quality can be obtained for a long period of time.

In the embodiment, when aggregated particle 92 and crystal particle 93 are caused to adhere onto base film 91, aggregated particle 92 and crystal particle 93 adhere with a coverage falling within the range of 10% or more to 20% or less so as to be distributed all over the surface of base film 91. The coverage, in a region of one discharge cell, area a to which aggregated particle 92 and crystal particle 93 adhere is expressed by a ratio of area b of one discharge cell and is calculated by an equation: coverage (%)=a/b×100. In an actual measuring method, for example, as shown in FIG. 14, an image of a region corresponding to one discharge cell partitioned by barrier rib 14 is photographed. The image is trimmed to have an (xxy) 1-cell size. The trimmed image is binarized into monochrome data. On the basis of the binarized data, area a of a black area configured by aggregated particles 92 and crystal particles 93 is calculated. Finally, area a is calculated by a/b×100.

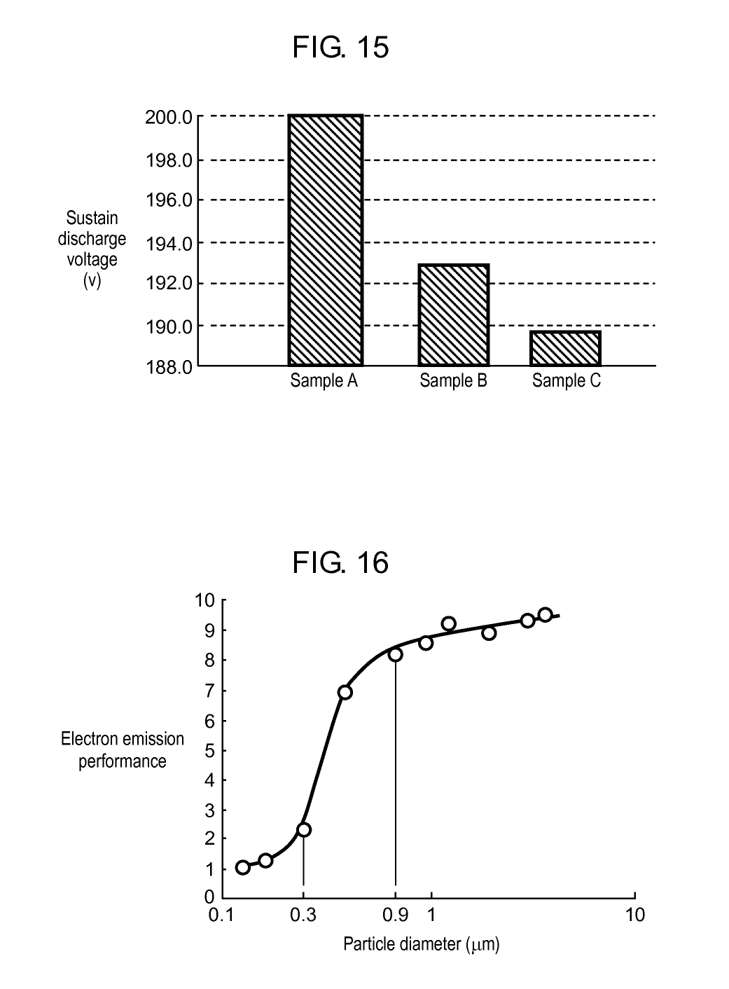

In order to check the effect of a PDP having a protective layer to which polyhedral crystal particles 92a and 92b and cubic crystal particles 93 are caused to adhere, samples are further produced to examine a sustain discharge voltage. As shown in FIG. 15, sample A is a PDP in which only aggregated particles 92 configured by MgO crystal particles 92a and 92b each having a CL emission peak in a wavelength region from 200 nm or more to 300 nm or less are dispersed on and caused to adhere to MgO base film 91. Each of samples B and C is a PDP in which aggregated particles 92 obtained by aggregating polyhedral MgO crystal particles 92b each having a particle diameter smaller than that of crystal particle 92a around MgO crystal particles 92a having an average particle diameter falling within the range of 0.9 μm to 2 μm and cubic MgO crystal particles 93 are dispersed all over the surface of MgO base film. Sample B and sample C have different relative permittivity c of dielectric layers 8. More specifically, sample B has relative permittivity c of dielectric layer 8 that is about 9.7. Sample C has relative permittivity c of dielectric layer 8 that is 7. Coverages of all the samples are about 13% that is 20% or less.

As shown in FIG. 15, sustain discharge voltages of samples B and C can be made lower than that of sample A. More specifically, a PDP having a protective layer to which aggregated particles 92 of polyhedral MgO crystal particles 92a and 92b having characteristics that perform CL emission having a peak in a wavelength region from 200 nm or more to 300 nm or less and cubic MgO crystal particle 93 having characteristics that perform CL emission having a peak in a wavelength region from 400 nm or more to 450 nm or less adhere can decrease the sustain discharge voltage. More specifically, a low power consumption of the PDP can be achieved. Furthermore, as is apparent from the characteristics of samples B and C, when the relative permittivity c of dielectric layer 8 is decreased, the sustain discharge voltage can be further reduced. In particular, according to an experiment by the present inventors, it is found that, when relative permittivity ε of dielectric layer 8 is set to 4 or more and 7 or less, the effect can be more remarkably obtained.

FIG. 16 shows an experiment result obtained by changing average particle diameters of MgO aggregated particle 92 in protecting layer and examining electron emission performance. In FIG. 16, the average particle diameter of aggregated particle 92 is measured by SEM observation of aggregated particle 92.

As shown in FIG. 16, when the average particle diameter decreases to about 0.3 μm, the electron emission performance becomes low, i.e., about 0.9 μm or more. In this case, high electron emission performance can be obtained.

In order to increase the number of electrons emitted in a discharge cell, the number of crystal particles per unit area on protective layer 9 is desirably large. According to the experiment by the present inventors, when crystal particles 92a, 92b, and 93 are present in a part corresponding to the top of barrier rib 14 that is in tight contact with protective layer 9, the top of barrier rib 14 may be broken. In this case, it is found that when the material of broken barrier rib 14 is placed on a phosphor, a phenomenon in which the corresponding cell is normally turned on or off occurs. Since the barrier rib breaking phenomenon does not easily occur unless crystal particles 92a, 92b, and 93 are present in the part corresponding to the top of the barrier rib, the probability of occurrence of breaking of barrier rib 14 increases when the number of crystal particles caused to adhere.

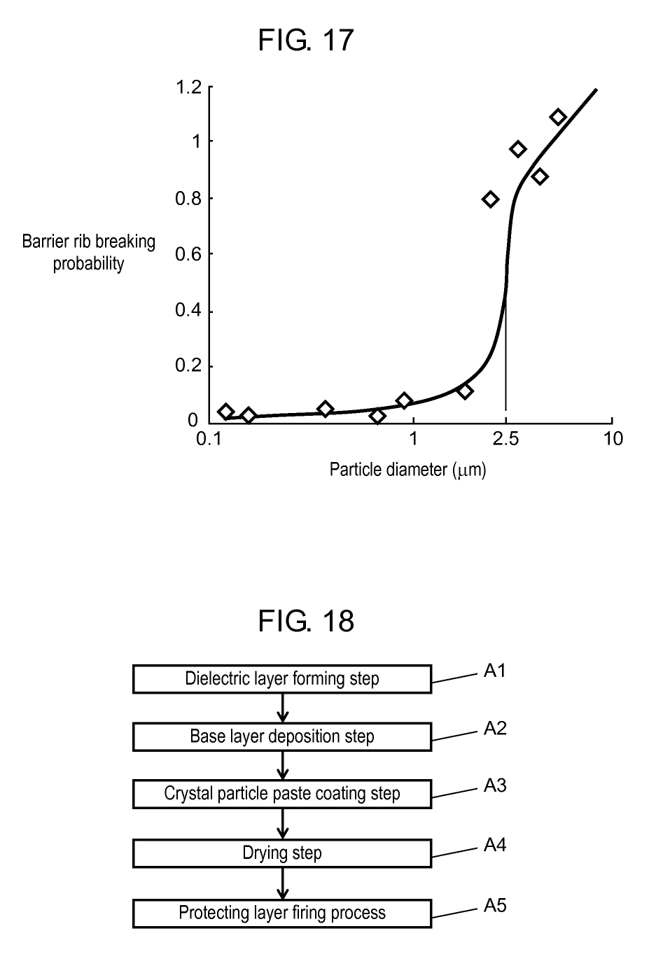

As shown in FIG. 17, when the particle diameter becomes about 2.5 μm, the probability of breaking of the barrier rib sharply increases. However, it is found that when the particle diameter is smaller than 2.5 μm, the probability of breaking of the barrier rib can be suppressed to a relatively low level.

On the basis of the above result, it is considered that aggregated particles 92 desirably have an average particle diameter of 0.9 μm or more and 2.5 μm or less. When the PDPs are actually mass-produced, a fluctuation in manufacture of crystal particles and a fluctuation in manufacture when a protecting layer is formed need to be considered.

In order to consider factors such as the fluctuations in manufacture, experiments are performed by using crystal particles having different particle diameter distributions. As a result, it is understood that, when aggregated particles 92 having an average particle diameter falling within the range of 0.9 μm to 2 μm is used, the effect described above can be stably obtained.

8. Method for Forming Protective Layer 9

As shown in FIG. 18, after dielectric layer forming step A1 in which dielectric layer 8 is formed is performed, in base film depositing step A2, base film 91 made of MgO containing A1 as an impurity is formed on dielectric layer 8 by a vacuum deposition method using, as a raw material, an MgO sintered body containing A1.

Thereafter, on unfired base film 91, the plurality of aggregated particles 92 and the plurality of crystal particles 93 are discretely dispersed and caused to adhere. More specifically, aggregated particles 92 and crystal particles 93 are dispersed all over the surface of base film 91.

In this step, an aggregated particle paste obtained by mixing polyhedral crystal particles 92a and 92b having a predetermined particle diameter distribution with a solvent is produced. A crystal particle paste obtained by mixing cubic crystal particles 93 with a solvent is produced. More specifically, the aggregated particle paste and the crystal particle paste are independently prepared. Therefore, the aggregated particle paste and the crystal particle paste are mixed with each other to produce a mixed crystal particle paste obtained by mixing polyhedral crystal particles 92a and 92b and crystal particles 93 in a solvent. Thereafter, in crystal particle paste applying step A3, the mixed crystal particle paste is applied onto base film 91 to form a mixed crystal particle paste film having an average film thickness of 8 μm to 20 μm. As a method of applying the mixed crystal particle paste onto base film 91, screen printing, spraying, spin coating, die coating, slit coating, or the like can also be used.

In this case, as the solvent used to produce the aggregated particle paste or the crystal particle paste, a solvent is suitable that has an affinity to MgO base film 91, aggregated particle 92, and crystal particle 93 and a vapor deposition at a room temperature that is about tens of Pa to make it possible to easily remove a vapor in drying step A4 that is the next step. For example, an organic solvent such as methyl methoxy butanol, terpineol, propylene glycol, or benzyl alcohol or a mixture solvent thereof is used. A viscosity of the paste including the solvent is several mPa·s to tens of mPa·s.

A substrate to which the mixed crystal particle paste is applied is immediately moved to drying step A4. In drying step A4, the mixed crystal particle paste film is dried at a low pressure. More specifically, the mixed crystal particle paste film is rapidly dried within tens of seconds in a vacuum chamber. Consequently, convection in the film that is conspicuous in baking does not occur. Consequently, aggregated particle 92 and crystal particle 93 more uniformly adhere onto base film 91. As a drying method in drying step A4, a baking method may be used depending on the solvents used in production of the mixed crystal particle paste.

In protective layer firing step A5, unfired base film 91 formed in base film depositing step A2 and the mixed crystal particle paste film passing through drying step A4 are simultaneously fired at a temperature of several hundred degrees C. By the firing, a solvent and a resin component that are left in the mixed crystal particle paste film are removed. As a result, protective layer 9 to which aggregated particles 92 configured by the plurality of polyhedral crystal particles 92a and 92b and cubic crystal particles 93 adhere is formed on base film 91.

According to the method, aggregated particles 92 and crystal particles 93 can be dispersed all over the surface of base film 91.

In addition to the above methods, a method of directly spraying a particle group together with a gas without using a solvent or the like or a method of dispersing particles by simply using the gravity may be used.

When only an aggregated particle paste obtained by mixing polyhedral crystal particles 92a and 92b having a predetermined particle diameter distribution in a solvent is used, aggregated particles 92 obtained by aggregating crystal particles 92a and 92b on base film 91 can be dispersed all over the surface.

Furthermore, when only an aggregated particle paste obtained by mixing crystal particles 92a in a solvent is used, aggregated particles 92 obtained by aggregating the plurality of crystal particles 92a can be dispersed all over the surface of base film 91.

9. Conclusion

First plasma display device 100 according to the embodiment includes PDP 1 that performs gradation display of an image by a sub-field driving method. PDP 1 has front plate 2 and rear plate 10 arranged to be opposed to front plate 2. Front plate 2 has display electrode 6, dielectric layer 8 to cover display electrode 6, and protective layer 9 to cover dielectric layer 8. Protective layer 9 includes base film 91 serving as a base layer formed on dielectric layer 8 and the plurality of aggregated particles 92 dispersed all over the surface of base film 91. Aggregated particle 92 is configured by the plurality of aggregated crystal particles 92a of a metal oxide. Furthermore, plasma display device 100 forms an image by a right-eye field in which a right-eye image signal is displayed and a left-eye field in which a left-eye image signal is displayed. The right-eye field and the left-eye field have a plurality of sub-fields. The first sub-field has a minimum luminance weight, the second sub-field has a maximum luminance weight, and the third and subsequent sub-fields have luminance weights decreasing in sequence.

Second plasma display device 100 according to the embodiment includes PDP 1 that performs gradation display of an image by a sub-field driving method. PDP 1 has front plate 2 and rear plate 10 arranged to be opposed to front plate 2. Front plate 2 has display electrode 6, dielectric layer 8 to cover display electrode 6, and protective layer 9 to cover dielectric layer 8. Protective layer 9 includes base film 91 formed on dielectric layer 8, a plurality of first particles dispersed all over the surface of base film 91, and a plurality of second particles dispersed all over the surface of the base layer. The first particle is aggregating particle 92 obtained by aggregating the plurality of crystal particles 92a of a metal oxide. The second particle is cubic crystal particle 93 made of a magnesium oxide. Furthermore, plasma display device 100 forms an image by a right-eye field in which a right-eye image signal is displayed and a left-eye field in which a left-eye image signal is displayed. The right-eye field and the left-eye field have a plurality of sub-fields. The first sub-field has a minimum luminance weight, the second sub-field has a maximum luminance weight, and the third and subsequent sub-fields have luminance weights decreasing in sequence.

Plasma display device 100 according to the embodiment has high electron emission performance and high charge retention performance. Furthermore, discharge delay occurring in high-speed drive having a short address period in which the right-eye field and the left-eye field are alternately repeated and displayed is suppressed. Consequently, a flicker of an image caused by a defective address operation is suppressed. Furthermore, crosstalk between a right-eye image and a left-eye image is suppressed.

In addition, the MgO film is illustrated as base film 91 in the above description. However, the performance required for base film 91 is to have higher sputter-resistant performance to protect the dielectric body against ion bombardment. According to the conventional PDP, the protective layer is made mainly of MgO in many cases in order to achieve the certain level of the electron emission performance and the sputter-resistant performance. In the embodiment, since the electron emission performance is dominantly controlled by aggregated particle 92, the base layer need not be made of MgO at all, and another material that is excellent in impact resistance such as Al₂O₃ may be used without a problem.

In the embodiment, an MgO particle is used as a single crystal particle. However, even though another single crystal particle or a crystal particle made of an oxide of a metal such as Sr, Ca, Ba, or Al having high electron emission performance like the MgO is used, the same effect as described above can be obtained. Thus, the seed particle is not limited to the MgO.

### INDUSTRIAL APPLICABILITY

As described above, the technique disclosed in this embodiment is useful in realizing the PDP having high-resolution and high-luminance display performance, keeping power consumption low.

### REFERENCE MARKS IN THE DRAWING

1 PDP

2 front plate

3 front glass substrate

4 scan electrode

4a, 5a transparent electrode

4b, 5b metal bus electrode

5 sustain electrode

6 display electrode

7 black stripe

8 dielectric layer

9 protective layer

10 rear plate

11 rear glass substrate

12 data electrode

13 base dielectric layer

14 barrier wall

15 phosphor layer

16 discharge space

21 image signal processing circuit

22 data electrode drive circuit

23 scan electrode drive circuit

24 sustain electrode drive circuit

25 timing generation circuit

91 base film

92 aggregated particle

92a, 92b, 93 crystal particle

100 plasma display device

1. A plasma display device comprising a plasma display panel that performs gradation display of an image by a sub-field driving method,
wherein the plasma display panel includes:
a front plate;
a rear plate disposed oppositely to the front plate;
wherein the front plate has a display electrode, a dielectric layer to cover the display electrode, and a protective layer to cover the dielectric layer,
wherein the protective layer includes a base layer formed on the dielectric layer and a plurality of aggregated particles dispersed all over a surface of the base layer, and the aggregated particles are formed of a plurality of aggregated crystal particles of a metal oxide,
wherein an image is formed of a right-eye field in which a right-eye image signal is displayed and a left-eye field in which a left-eye image signal is displayed,
wherein the right-eye field and the left-eye field have a plurality of sub-fields, of which a first sub-field has a minimum luminance weight, a second sub-field has a maximum luminance weight, and third and subsequent sub-fields have luminance weights decreasing in sequence.

2. A plasma display device comprising a plasma display panel that performs gradation display of an image by a sub-field driving method,
wherein the plasma display panel includes:
a front plate;
a rear plate disposed oppositely to the front plate;
wherein the front plate has a display electrode, a dielectric layer to cover the display electrode, and a protective layer to cover the dielectric layer,
wherein a plurality of first particles dispersed all over a surface of the base layer, and a plurality of second particles dispersed all over the surface of the base layer, the first particles are aggregated particles that include the plurality of aggregated crystal particles of a metal oxide, the second particles are cubic crystal particles made of a magnesium oxide,
wherein an image is formed of a right-eye field in which a right-eye image signal is displayed and a left-eye field in which a left-eye image signal is displayed,
wherein the right-eye field and the left-eye field have a plurality of sub-fields, of which a first sub-field has a minimum luminance weight, a second sub-field has a maximum luminance weight, and third and subsequent sub-fields have luminance weights decreasing in sequence.

3. The plasma display device according to claim 1, wherein
an average particle diameter of the aggregated particles is not less than 0.9 μm, not more than 2.0 μm.

4. The plasma display device according to claim 1, wherein
the crystal particle of the metal oxide has a form of a polyhedron having seven or more faces.

5. The plasma display device according to claim 1, wherein
the base layer contains a magnesium oxide.

6. The plasma display device according to claim 2, wherein
an average particle diameter of the aggregated particles is not less than 0.9 μm, not more than 2.0 μm.

7. The plasma display device according to claim 2, wherein
the crystal particle of the metal oxide has a form of a polyhedron having seven or more faces.

8. The plasma display device according to claim 2, wherein
the base layer contains a magnesium oxide.
